(19) United States
(12) Patent Application Publication
(10) Pub. No.: US 2015/0121092 A1
(43) Pub. Date: Apr. 30, 2015

(54) REAL TIME GENERATING DEVICE

(71) Applicant: Quanta Computer Inc., Taoyuan Shien (TW)

(72) Inventor: Li-Te HUNG, Taipei City (TW)

(73) Assignee: QUANTA COMPUTER INC., Taoyuan Shien (TW)

(21) Appl. No.: 14/296,543

(22) Filed: Jun. 5, 2014

(30) Foreign Application Priority Data
Oct. 25, 2013 (TW) 102138697

(51) Int. Cl. G06F 1/26

(52) U.S. Cl. CPC G06F 1/26
USPC 713/300; 700/16

(57) ABSTRACT

A real time generating device applied in an electronic apparatus is provided. The real time generating device includes a real time clock module and an energy harvesting module. The real time clock module is configured to generate real time information. The energy harvesting module electrically connected to the real time clock module harvests surrounding environment energy to generate electrical energy and supply power to the real time clock module.

### RELATED APPLICATIONS

This application claims priority to Taiwan Application Serial Number 102138697, filed Oct. 25, 2013, the entirety of which is herein incorporated by reference.

### BACKGROUND

1. Technical Field

The present disclosure relates to a real time generating technique. More particularly, the present disclosure relates to real time generating device.

2. Description of Related Art

A real time clock (RTC) is an electronic device which is capable of generating real time as a clock. The real time clocks are widely used in personal computers, servers, mobile phones, embedded systems and many other electronic devices which require information of precise time. The real time clock is usually powered by a lithium battery to keep the real time clock running when the electronic device with the real time clock is off. However, the electronic device is usually designed with a specific mechanism to make the lithium battery supplying power for the real time clock replaceable in case the battery runs out. Consequently, extra costs for the mechanism are needed, and it is inconvenient for users to change the battery and reset the system of the electronic device.

Therefore, it is very important to design a novel real time generating device which can solve the abovementioned problems.

### SUMMARY

In one aspect, the present disclosure is related to a real time generating device applied in an electronic apparatus. The real time generating device includes a real time clock module and an energy harvesting module. The real time clock module is configured to generate real time information. The energy harvesting module is electrically connected to the real time clock module. The energy harvesting module is configured for harvesting surrounding environment energy to generate electrical energy and supply power to the real time clock module.

According to an embodiment of the present disclosure, the abovementioned energy harvesting module is a micro-electro-mechanical-system energy harvesting module, and the energy harvesting module is assembled together with at least one micro-electro-mechanical-system sensor of the electronic apparatus.

According to another embodiment of the present disclosure, the abovementioned real time generating device of further includes an energy storage. The energy storage is electrically connected to the energy harvesting module and the real time clock module. The energy storage is configured for storing the electrical energy generated by the energy harvesting module, in which the energy storage is a capacitor or a super capacitor.

According to another embodiment of the present disclosure, the abovementioned real time generating device of further includes a voltage adjusting module. The voltage adjusting module is electrically connected to the energy harvesting module and the real time clock module. The voltage adjusting module is configured for adjusting an output voltage generated by the energy harvesting module and for transmitting the adjusted output voltage to the real time clock module.

According to another embodiment of the present disclosure, the energy harvesting module is further configured for providing power capacity data.

According to another embodiment of the present disclosure, the abovementioned real time generating device of further includes a monitoring module. The monitoring module is configured for receiving the power capacity data provided by the energy harvesting module such that the monitoring module generates warning information when the power capacity data indicates a low power status, or when the monitoring module is not capable of reading the power capacity data.

According to another embodiment of the present disclosure, the abovementioned real time generating device of further includes a charge controller module. The charge controller module is configured for receiving the power capacity data and for controlling a charging voltage, a charging current, a charging starting time, a charging ending time, or a combination thereof, of the energy harvesting module toward the real time clock module according to the power capacity data.

According to another embodiment of the present disclosure, the abovementioned real time clock module is further electrically connected to a system power supply of the electronic apparatus, and the system power supply and the energy harvesting module supply power to the real time clock module simultaneously.

According to another embodiment of the present disclosure, the abovementioned real time generating device of further includes a control module. The control module is electrically connected to the energy harvesting module, a system power supply of the electronic apparatus and the real time clock module. The control module controls at least one of the group consisting of the energy harvesting module and the system power supply to supply power to the real time clock module according to a power signal of the system power supply or a power-on signal.

According to another embodiment of the present disclosure, the abovementioned real time clock module further includes a storage unit. The storage unit is configured for storing at least one configuration datum of the electronic apparatus.

By utilizing the energy harvesting module, the surrounding environment energy can be harvested to provide stable power for the real time clock module and hence the abovementioned purpose can be reached.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a real time generating device in accordance with one embodiment of the present disclosure;

FIG. 2 is a circuit diagram of a real time generating device in accordance with one embodiment of the present disclosure;

FIG. 3 is circuit diagram of a real time generating device in accordance with one embodiment of the present disclosure;

FIG. 4 is block diagram of a real time generating device in accordance with one embodiment of the present disclosure;

FIG. 5 is a is a circuit diagram of a real time generating device in accordance with one embodiment of the present disclosure;

FIG. 6 is a circuit diagram of a real time generating device in accordance with one embodiment of the present disclosure;

FIG. 7 is a block diagram of a real time generating device in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

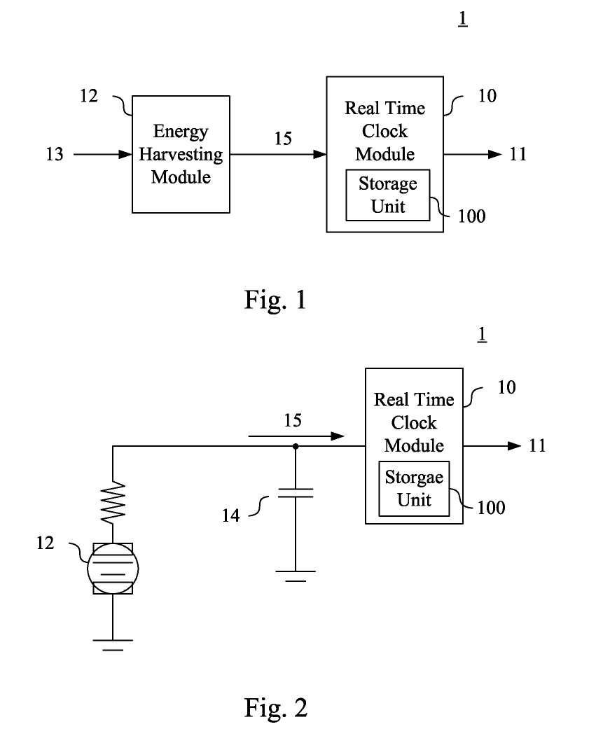

Reference is made first to FIG. 1 and FIG. 2 simultaneously. FIG. 1 is a block diagram of a real time generating device 1 in accordance with one embodiment of the present disclosure. FIG. 2 is a circuit diagram of a real time generating device 1 in accordance with one embodiment of the present disclosure.

In an embodiment of the present disclosure, the real time generating device 1 is applied in an electronic apparatus, for example but not limited to, a computer system like a desktop computer or a laptop, or a handheld electronic device like a smart phone or a tablet computer (not depicted) such that the real time generating device 1 generates corresponding information of real time required by the electronic apparatus. The real time generating device 1 includes a real time clock module 10 and an energy harvesting module 12.

The real time clock module 10 is configured for generating real time information 11. In an embodiment of the present disclosure, the real time information 11 is corresponding time information of the electronic apparatus. Taking a laptop for example, when the south bridge chip of the laptop is not powered by the system, the real time clock module 10 can still generate the real time information 11 such as the date and time information of the laptop.

In an embodiment of the present disclosure, the real time clock module 10 further includes a storage unit 100. The storage unit 100 is configured for storing at least one configuration datum of the electronic apparatus. For example, the storage unit 100 can be a complementary metal-oxide-semiconductor (CMOS) memory or other types of memory, such that the storage unit 100 stores information like the number of hard disks, the type of hard disks, the graphic controller, the memory and the verification value of a laptop computer. In an embodiment, the real time clock module 10 can generate, for example but not limited to, interruption or warning information according to configuration data.

The energy harvesting module 12 is electrically connected to the real time clock module 10. The energy harvesting module 12 is configured for harvesting surrounding environment energy 13 to generate electrical energy, and to supply power 15 to the real time clock module 10. In an embodiment of the present disclosure, the real time generating device 1 further includes an energy storage 14. The energy storage 14 is electrically connected to the energy harvesting module 12 and the real time clock module 10. The energy storage 14 is configured for storing the electrical energy generated by the energy harvesting module 12. When the energy harvesting module 12 is not able to supply enough power, the real time clock module 10 can be powered by the discharge of the energy storage 14. In an embodiment of the present disclosure, the energy storage 14 is a capacitor or a super capacitor.

As illustrated in FIG. 2, in an embodiment of the present disclosure, the energy harvesting module 12 is implemented by utilizing micro-electro-mechanical-system technique. In other embodiments, the energy harvesting module 12 can also be implemented by utilizing other techniques which are capable of harvesting the surrounding environment energy 13. The surrounding environment energy 13 can be but not limited to vibration energy, temperature difference, wind power or electromagnetic power.

In an embodiment of the present disclosure, the energy harvesting module 12 can be implemented by micro-electro-mechanical-system components which include piezoelectric generators, such that the vibration generated by each module of the electronic apparatus, for example, the CPU or the hard disks can be transformed to electric energy to generate the power 15. In an embodiment, the piezoelectric generators can be designed to have a resonant frequency which is the same as the resonant frequency generated by the electronic apparatus during operation such that the efficient power generation can be achieved.

In another embodiment, the energy harvesting module 12 can be implemented by micro-electro-mechanical-system components which include thermoelectric power generators. For example, the thermal energy generated by the cooling devices (e.g., heat pipe) of the electronic apparatus can be transformed to electric energy to generate the power 15.

In another embodiment, the energy harvesting module 12 can be implemented by wind-driven micro-electro-mechanical-system components which include piezoelectric thin film cantilevers. For example, the airflow generated by the cooling fans of the electronic apparatus can be transformed to electric energy to generate the power 15.

In another embodiment, the energy harvesting module 12 can be implemented by components which can receive electromagnetic waves. For example, the electromagnetic energy of the electromagnetic waves collected by the antenna of the wireless network adapter of the electronic apparatus can be transformed to electric energy to generate the power 15. In another embodiment, the energy harvesting module 12 can be implemented by an oscillator-type short-range sensor such that when the oscillation condition is changed due to subjects (e.g., people) approaching, corresponding current is generated and the power 15 is hence generated.

Therefore, the real time clock module 10 can obtain stable power supply due to the energy harvesting module 12. It is not necessary to change batteries regularly. Consequently, it is not needed to impose the holes or components for changing the batteries of the electronic apparatus. The purpose of environment protection is also achieved due to the reduced battery consumption. Moreover, when the energy harvesting module 12 is implemented by micro-electro-mechanical-system component, the energy harvesting module 12 can be assembled together with other micro-electro-mechanical-system component (e.g., G-sensor) of the electronic apparatus, such that the supplied voltage can be shared and the circuit can be combined. For example, the same interface can be used such that the operation efficiency is improved and the volume required is reduced.

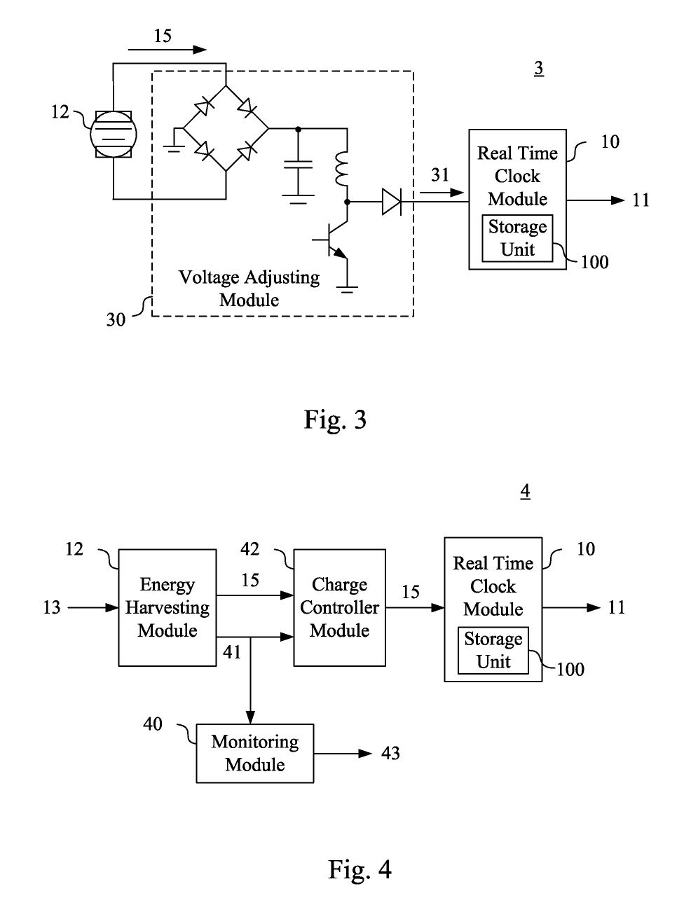

Reference is made also to FIG. 3. FIG. 3 is a circuit diagram of a real time generating device 3 in accordance with one embodiment of the present disclosure. The real time generating device 3 is similar to the real time generating device 1 illustrated in FIG. 1 and FIG. 2, which also includes the real time clock module 10 and the energy harvesting module 12. Their functions and operations are similar and hence are not described again herein. In this embodiment, the real time generating device 3 further includes a voltage adjusting module 30.

The voltage adjusting module 30 is electrically connected to the energy harvesting module 12 and the real time clock module 10. The voltage adjusting module 30 is configured for adjusting the power 15 generated by the energy harvesting module 12 with an initial voltage level to another power 31 with a different voltage level. Since the accuracy of the real time clock module 10 corresponds to the voltage of the supplied power, when the voltage of the supplied power drops, the accuracy of the real time clock module 10 will drop accordingly. Therefore, in a preferred embodiment, the voltage of the power 15 generated by the energy harvesting module 12 is controlled to be larger than the minimal voltage requirement of the real time clock module 10. The voltage adjusting module 30 can adjust the voltage of the power 15 to meet the voltage required by the real time clock module 10. In an embodiment of the present disclosure, the voltage adjusting module 30 includes a maximum power point tracking (MPPT) unit (not depicted) such that maximum power can be obtained.

For example, in an embodiment of the present disclosure, the real time clock module 10 operates based on 2.5˜3.47 volts of DC power. However, the energy harvesting module 12 capable of transforming electromagnetic waves to electrical energy can only output around 0.2 volts DC power 15 when the energy harvesting module 12 receives 2.4 GHz wireless local area network (WLAN) waves, in which the received waves are, for example but not limited to, rectified by a bridge rectifier or filtered by a RC circuit. In this example, the voltage adjusting module 30 can transform the 0.2 volts DC power 15 to the DC power 31 which is at least 2.5 volts, such that the real time clock module 10 can function properly.

It has to be explained that the voltage adjusting module 30 depicted in FIG. 3 is an example for illustration. In other embodiments, the voltage adjusting module 30 can be realized by other circuits with different structures or components which can reach the purpose of adjusting the voltage levels.

Additional reference is made to FIG. 4. FIG. 4 is a block diagram of a real time generating device 4 in accordance with one embodiment of the present disclosure. The real time generating device 4 is similar to the real time generating device 1 illustrated in FIG. 1 and FIG. 2, which also includes the real time clock module 10 and the energy harvesting module 12. Their functions and operations are similar and hence are not described again herein. In this embodiment, the real time generating device 4 further includes a monitoring module 40 and a charge controller module 42.

In this embodiment, the energy harvesting module 12 is further configured for providing power capacity data 41. In an embodiment of the present disclosure, the power capacity data 41 is the amount of remaining electrical energy which has been generated by the energy harvesting module 12 and is not yet consumed by the real time clock module 10. In another embodiment of the present disclosure, the power capacity data 41 can be, for example but not limited to, the power generation ability of the energy harvesting module 12 or the amount of energy stored in the energy storage 14 as illustrated in FIG. 2.

The monitoring module 40 is configured for receiving the power capacity data 41 provided by the energy harvesting module 12 such that the monitoring module 40 generates warning information 43 when the power capacity data 41 indicates a low power status, or when the monitoring module 40 is not capable of reading the power capacity data 41. The charge controller module 42 is configured for receiving the power capacity data 41 and for controlling a charging voltage, a charging current, a charging starting time, a charging ending time, or a combination thereof, of the energy harvesting module 12 toward the real time clock module 10 according to the power capacity data 41.

In an embodiment, the monitoring module 40 can be realized by an independent component. In another embodiment, the monitoring module 40 can be integrated in other modules of the electronic apparatus, for example but not limited to, basic input/output system (BIOS). The monitoring module 40 can receive the power capacity data 41 provided by the energy harvesting module 12 through, for example but not limited to, an universal serial bus (USB) interface. The monitoring module 40 can generate, for example but not limited to, a software warning message or a hardware alert tone to inform users that the energy harvesting module 12 is not functioning properly.

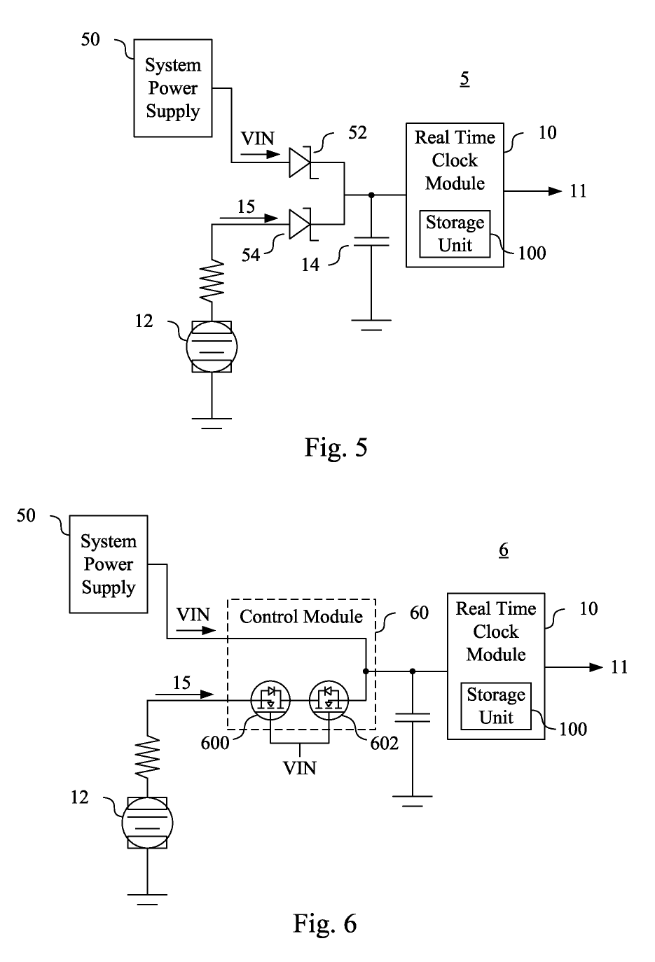

Reference is now made to FIG. 5. FIG. 5 is a is a circuit diagram of a real time generating device 5 in accordance with one embodiment of the present disclosure. The real time generating device 5 is similar to the real time generating device 1 illustrated in FIG. 1 and FIG. 2, which also includes the real time clock module 10 and the energy harvesting module 12. Their functions and operations are similar and hence are not described again herein. In this embodiment, the real time clock module 10 is further electrically connected to a system power supply 50 of the electronic apparatus. The system power supply 50 and the energy harvesting module 12 can supply power to the real time clock module 10 simultaneously.

The system power supply 50 supplies power to the electronic apparatus when the electronic apparatus is powered up such that the electronic apparatus can function properly. In this embodiment, when the electronic apparatus is operating, the system power supply 50 can output the power signal VIN to the real time clock module 10 such that the real time clock module 10 can function based on the power 15 provided by the energy harvesting module 12 and the power signal VIN provided by the system power supply 50 simultaneously. When the electronic apparatus is not operating, the system power supply 50 stops outputting the power signal VIN and the real time clock module 10 functions based on the power 15 provided by the energy harvesting module 12. In an embodiment of the present disclosure, the system power supply 50 and the energy harvesting module 12 are electrically connected to the real time clock module 10 through the Schottky Diodes 52 and 54, respectively such that the power signal VIN and the power 15 are forwarded to the real time clock module 10 in one-way direction.

Reference is made also to FIG. 6. FIG. 6 is a circuit diagram of a real time generating device 6 in accordance with one embodiment of the present disclosure. The real time generating device 6 is similar to the real time generating device 1 illustrated in FIG. 1 and FIG. 2, which also includes the real time clock module 10 and the energy harvesting module 12. Their functions and operations are similar and hence are not described again herein. In this embodiment, the real time generating device 6 further includes a control module 60.

The control module 60 is electrically connected to the energy harvesting module 12, the system power supply 50 of the electronic apparatus and the real time clock module 10. The control module 60 controls at least one of the group consisting of the energy harvesting module 12 and the system power supply 50 to supply power to the real time clock module 10 according to the power signal VIN of the system power supply 50 or a power-on signal (not depicted).

In this embodiment, the control module 60 includes series-connected transistor switches 600 and 602, which are electrically connected between the energy harvesting module 12 and the real time clock module 10. The transistor switches 600 and 602 are controlled by the power signal VIN of the system power supply 50.

When the electronic apparatus is operating, the system power supply 50 outputs the power signal VIN to the real time clock module 10. In this time, the transistor switches 600 and 602 receive the power signal VIN with first voltage level, and hence the transistor switches 600 and 602 are open. Consequently, the real time clock module 10 is powered by the system power supply 50. When the electronic apparatus is not operating, the system power supply 50 stops outputting the power signal VIN to the real time clock module 10. In this time, the transistor switches 600 and 602 are closed. Consequently, the real time clock module 10 is powered by the energy harvesting module 12.

In another embodiment of the present disclosure, when the electronic apparatus is not operating, and is connected to a power source through a power adapter or is powered by a battery, the system power supply 50 can still provide the power signal VIN to the real time clock module 10. Consequently, the transistor switches 600 and 602 are open and the real time clock module 10 is powered by the system power supply 50. In this embodiment, the energy harvesting module 12 provides power 15 to the real time clock module 10 only when the electronic apparatus can not obtain power through the power adapter or the battery.

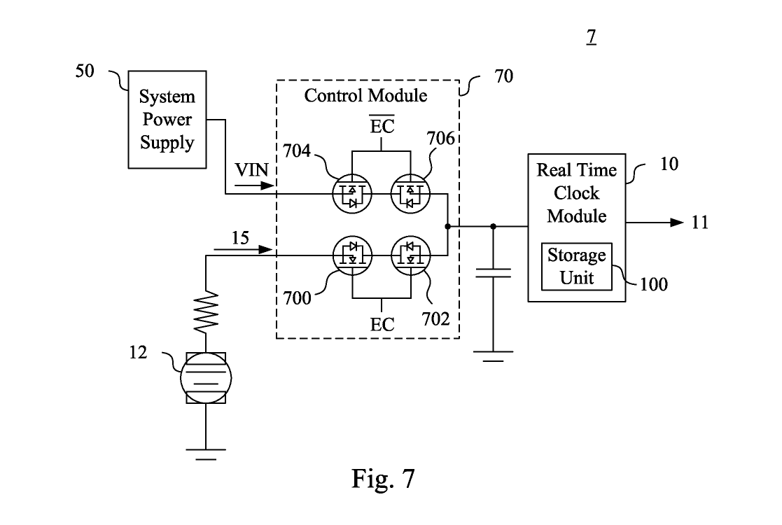

Additional reference is now made to FIG. 7. FIG. 7 is a block diagram of a real time generating device 7 in accordance with one embodiment of the present disclosure. The real time generating device 7 is similar to the real time generating device 1 illustrated in FIG. 1 and FIG. 2, which also includes the real time clock module 10 and the energy harvesting module 12. Their functions and operations are similar and hence are not described again herein. In this embodiment, the real time generating device 7 further includes a control module 70.

Similar to the embodiment illustrated in FIG. 6, the control module 70 is electrically connected to the energy harvesting module 12, the system power supply 50 of the electronic apparatus and the real time clock module 10. The control module 70 controls at least one of the group consisting of the energy harvesting module 12 and the system power supply 50 to supply power to the real time clock module 10

In this embodiment, the control module 70 includes series-connected transistor switches 700 and 702, which are electrically connected between the energy harvesting module 12 and the real time clock module 10. The control module 70 further includes series-connected transistor switches 704 and 706, which are electrically connected between the system power supply 50 and the real time clock module 10. The transistor switches 700 and 702 are controlled by a power-on signal EC of the electronic apparatus, while the transistor switches 704 and 706 are controlled by a reversed a power-on signal E̅C̅.

The power-on signal EC is generated by, for example but not limited to, an embedded controller after the electronic apparatus is powered on. When the electronic apparatus is operating, the transistor switches 700 and 702 are open and the transistor switches 704 and 706 are closed due to the power-on signal EC. Consequently, the real time clock module 10 is powered by the system power supply 50. When the electronic apparatus is not operating, the voltage level of the power-on signal EC changes accordingly, and hence the transistor switches 700 and 702 are closed while the transistor switches 704 and 706 are open. Consequently, the real time clock module 10 is powered by the energy harvesting module 12.

It has to be explained that the control modules 60 and 70 mentioned above are examples for illustration. In other embodiments, the control modules 60 and 70 can be realized by other circuits with different structures or components which can control one of the group consisting of the energy harvesting module 12 and the system power supply 50 to supply power to the real time clock module 10 such that the electrical energy generated by the energy harvesting module 12 can be saved or used more efficiently.

The above illustrations include exemplary operations, but the operations are not necessarily performed in the order shown. Operations may be added, replaced, changed order, and/or eliminated as appropriate, in accordance with the spirit and scope of various embodiments of the present disclosure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A real time generating device applied in an electronic apparatus, the real time generating device comprising:
a real time clock module, configured for generating real time information; and
an energy harvesting module electrically connected to the real time clock module, the energy harvesting module being configured for harvesting surrounding environment energy to generate electrical energy, and to supply power to the real time clock module.

2. The real time generating device of claim 1, wherein the energy harvesting module is a micro-electro-mechanical-system energy harvesting module which is assembled together with at least one micro-electro-mechanical-system sensor of the electronic apparatus.

3. The real time generating device of claim 1 further comprising:
an energy storage electrically connected to the energy harvesting module and the real time clock module, the energy storage being configured for storing the electrical energy generated by the energy harvesting module, wherein the energy storage is a capacitor or a super capacitor.

4. The real time generating device of claim 1 further comprising:
a voltage adjusting module electrically connected to the energy harvesting module and the real time clock module, the voltage adjusting module being configured for adjusting an output voltage generated by the energy harvesting module and for transmitting the adjusted output voltage to the real time clock module.

5. The real time generating device of claim 1, wherein the energy harvesting module is further configured for providing power capacity data.

6. The real time generating device of claim 5 further comprising:
a monitoring module, configured for receiving the power capacity data provided by the energy harvesting module such that the monitoring module generates warning information when the power capacity data indicating a low power status, or when the monitoring module being not capable of reading the power capacity data.

7. The real time generating device of claim 5 further comprising:
a charge controller module, configured for receiving the power capacity data and for controlling a charging voltage, a charging current, a charging starting time, a charging ending time, or a combination thereof, of the energy harvesting module toward the real time clock module according to the power capacity data.

8. The real time generating device of claim 1, wherein the real time clock module is further electrically connected to a system power supply of the electronic apparatus, and the system power supply and the energy harvesting module supply power to the real time clock module simultaneously.

9. The real time generating device of claim 1 further comprising:
a control module electrically connected to the energy harvesting module, a system power supply of the electronic apparatus and the real time clock module, wherein the control module controls at least one of the group consisting of the energy harvesting module and the system power supply to supply power to the real time clock module according to a power signal of the system power supply or a power-on signal.

10. The real time generating device of claim 1, wherein the real time clock module further comprises a storage unit, the storage unit being configured for storing at least one configuration datum of the electronic apparatus.
